(19) United States
(12) Patent Application Publication
(10) Pub. No.: US 2021/0034004 A1
(43) Pub. Date: Feb. 4, 2021

(54) IMAGE FORMING APPARATUS

(71) Applicant: HEWLETT-PACKARD DEVELOPMENT COMPANY, L.P., Spring, TX (US)

(72) Inventor: Hoil LEE, Suwon-Si (KR)

(73) Assignee: HEWLETT-PACKARD DEVELOPMENT COMPANY, L.P., Spring, TX (US)

(21) Appl. No.: 16/964,897

(22) PCT Filed: Jan. 14, 2019
(86) PCT No.: PCT/US2019/013486

§ 371 Date: Jul. 24, 2020

(30) Foreign Application Priority Data
Jan. 31, 2018 (KR) 10-2018-0012142

(51) Int. Cl. G03G 15/00

(52) U.S. Cl. CPC G03G 15/6552; G03G 15/6511; G03G 2215/00586; G03G 2215/00421; G03G 2215/0634; G03G 15/657

(57) ABSTRACT

The image forming apparatus includes a main body, a pick-up device to pick up a printing medium, a developing device to develop an image on a side of the printing medium picked up by the pick-up device, a fixing device to fix the image developed on the side of the printing medium, a paper reverse device to guide the printing medium from a transfer direction of the printing medium passing through the fixing device, through a reverse path to the developing device and the fixing device, to develop and fix another image on other side of the printing medium, a discharging device to discharge the printing medium outside the main body, a post-processing device provided in the main body, and a post-processing path selection device rotatable to a first position to guide the printing medium through a discharge path to guide the printing medium passing through the fixing device to the discharging device and a second position to guide the printing medium from the discharge path to a post-processing path branched from the discharge path, to guide the printing medium to the post-processing device.

### BACKGROUND

An image forming apparatus refers to an apparatus which forms an image of a printing medium according to an input image signal. For example, a printer, a copier, a facsimile, and a multi-function apparatus which combines the functions thereof and implements the integrated functions correspond to an image forming apparatus.

Some image forming apparatus includes a paper reverse device which reverses papers therein, to implement a duplex printing for the user convenience.

### BRIEF DESCRIPTION OF THE DRAWINGS

FIG. 1 is a perspective view of an image forming apparatus, according to an example;

FIG. 2 is a cross-sectional view of an image forming apparatus, according to an example of the present disclosure;

FIG. 3 is a perspective view illustrating a state in which a paper reverse device of FIG. 1 is open;

FIG. 4 is a perspective view illustrating a paper reverse device of FIG. 1;

FIG. 5A is a cross-sectional view of a paper reverse device in which a second guide member of a reverse path selection device is disposed at a third position;

FIG. 5B is a cross-sectional view of a paper reverse device in which a second guide member of a reverse path selection device is disposed at a fourth position;

FIG. 6 is a perspective view illustrating a path selection device of FIG. 1;

FIG. 7A is a diagram illustrating a printing path and discharging path of an image forming apparatus;

FIGS. 7B, 7C and 7D are diagrams respectively illustrating a post-processing path, reverse path and reentry path of an image forming apparatus;

FIG. 8A is a diagram illustrating a printing path and discharging path of an image forming apparatus, according to another example;

FIGS. 8B, 8C and 8D are diagrams respectively illustrating a post-processing path, reverse path and reentry path of an image forming apparatus, according to another image forming apparatus;

FIG. 9A is a cross-sectional view illustrating a printing path and discharging path of an image forming apparatus, according to another example; and

FIGS. 9B, 9C and 9D are diagrams respectively illustrating a post-processing path, reverse path and reentry path of an image forming apparatus, according to another example.

### DETAILED DESCRIPTION

the related-art image forming apparatus which is capable of duplex printing has its paper reverse device disposed therein and thus, It can be that the configuration of the components is complex. In addition, as the paper feed path becomes long and complex, It can be that the paper printing speed is slow. Furthermore, when a post-processing apparatus is provided in the related-art image forming apparatus having a duplex printing function, a path for transferring papers to the post-processing apparatus is not provided, which is inconvenient.

Certain examples of the disclosure will now be described in greater detail with reference to the accompanying drawings. However, it is to be understood that the present disclosure is not limited to a specific example, but includes all modifications without departing from the scope and spirit of the present disclosure. The description of the example complete the present disclosure and is provided to give information of the full scope of the disclosure to those skilled in the art. In the accompanying drawings, the elements are illustrated in enlarged scale for the convenience of explanation, and the ratio of each of the elements may be exaggerated or reduced.

In the present disclosure, relational terms such as first and second, and the like, may be used to distinguish one entity from another entity, without necessarily implying any actual relationship or order between such entities. The terms may be only used to differentiate one component from other components. For example, a first element may be named a second element without departing from the scope of right of various example, and similarly, a second element may be named a first element.

Unless indicated otherwise, it is to be understood that all the terms used in the disclosure including technical and scientific terms has the same meaning as those that are understood by those who skilled in the art.

Hereinafter, a rough structure of an image forming apparatus 1, a paper reverse device 200 and post-processing path A according to an example will be described in detail with reference to the accompanying drawings.

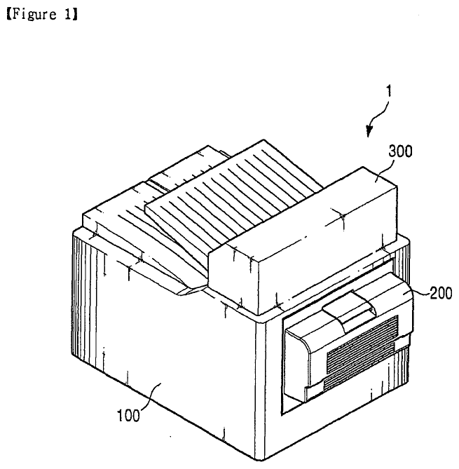

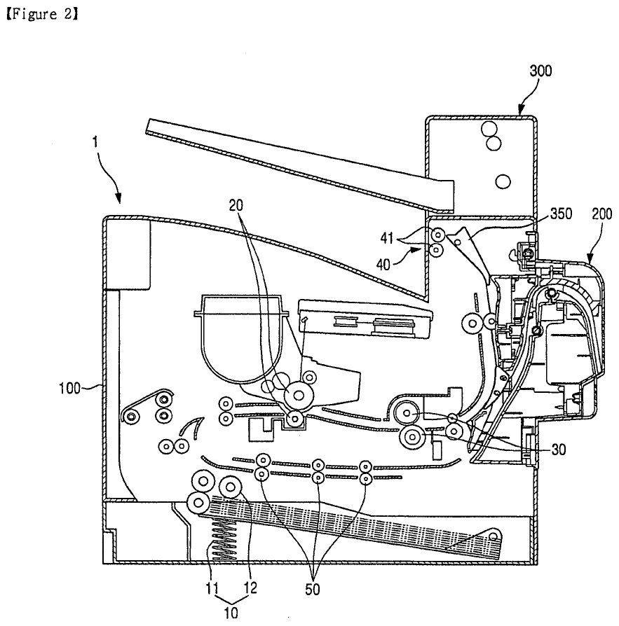

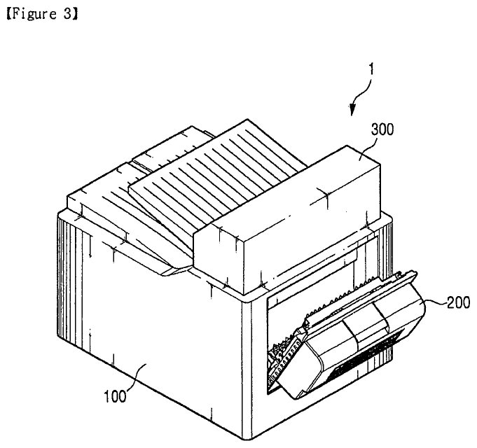

FIG. 1 is a perspective view illustrating an image forming apparatus, according to an example. FIG. 2 is a cross-sectional view illustrating an image forming apparatus, according to an example. FIG. 3 is a perspective view illustrating a state in which a paper reverse device of FIG. 1 is open.

Referring to FIG. 1, the image forming apparatus 1 may include a main body 100, a paper reverse device 200, and a post-processing device 300.

Referring to FIG. 2, the main body 100 forms the exterior of the image forming apparatus 1, and includes a pick-up device 10, a developing device 20, a fixing device 30, a discharging device 40, a guide transfer roller 50, and a post-processing path selection device 350.

The pick-up device 10 is installed inside the main body 100 and supplies printing media such as papers to the developing device 20, and includes a feed cassette 11 and a pick-up roller 12.

The developing device 20 is disposed inside the main body 100, and develops a toner image on one side of a paper transferred by the pick-up device 10. The fixing device 30 is disposed inside the main body 100, and fixes a toner image developed on one side of a paper with heat and pressure. The discharging device 40 is provided with a discharging roller 41 and discharges a paper for which printing is completed outside the main body.

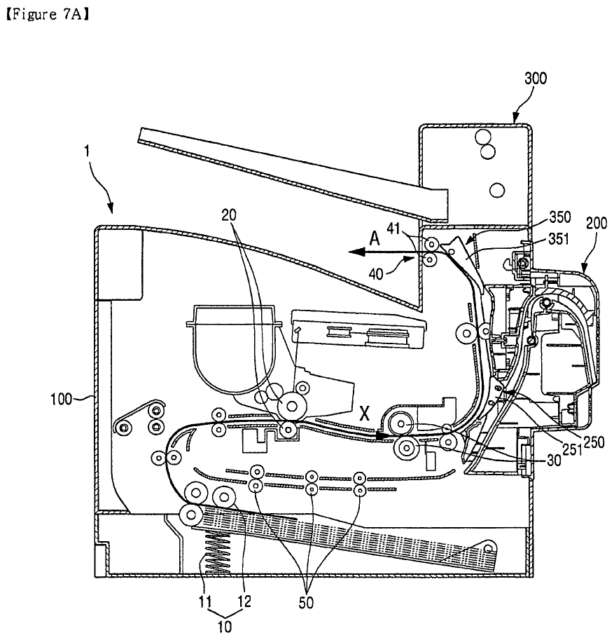

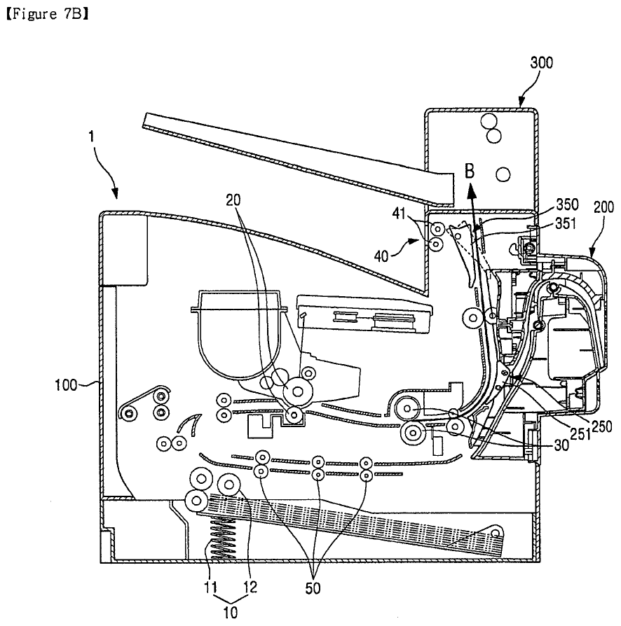

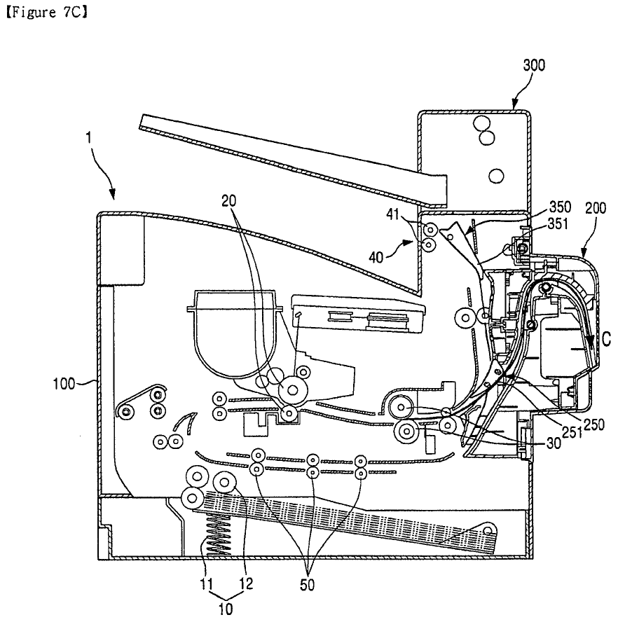

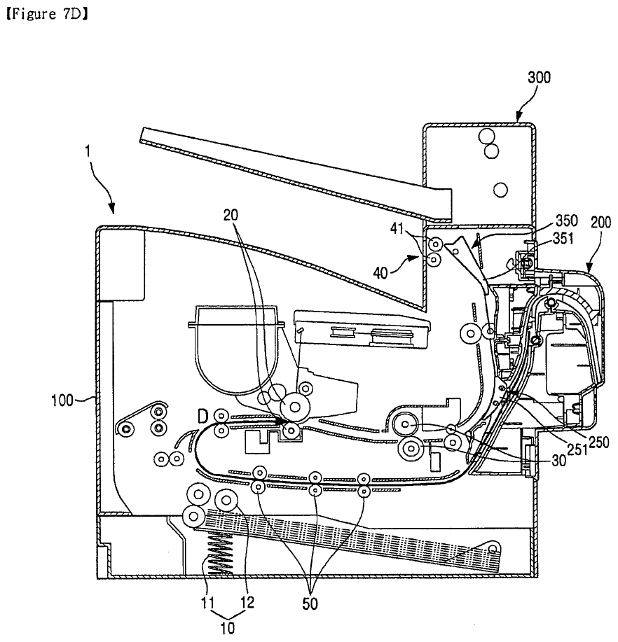

The guide transfer roller 50 is disposed on a reentry path (D, see FIG. 7D) guiding a paper reversed in the paper reverse device 200 to the developing device 20. The guide transfer roller 50 is disposed at predetermined gaps, and, for example, disposed at shorter distances than a longitudinal direction of a paper being transferred.

The paper reverse device 200 reverses a transfer direction of a paper to develop and fix a toner image on the other side of the paper. Referring to FIG. 3, the paper reverse device 200 may be hinge-connected to the main body 100. In addition, the paper reverse device 200 may be detachably combined with the main body 100. Accordingly, in the case where additional repair or replacement is necessary for the paper reverse device 200, it is possible to rotate the paper reverse device 200 and open it so that it is exposed from the main body 100 or to detach it, which makes repairing more convenient. The detailed description of other structures and operations of the paper reverse device will be described below.

The post-processing device 300 is an apparatus which performs post-processing, such as stamping, punching and the like, with respect to a paper for which printing is completed. The post-processing device 300 is provided in the main body 100 and accordingly, a post-processing path (B, see FIG. 7B) guided to the post-processing device 300 is formed inside the main body 100.

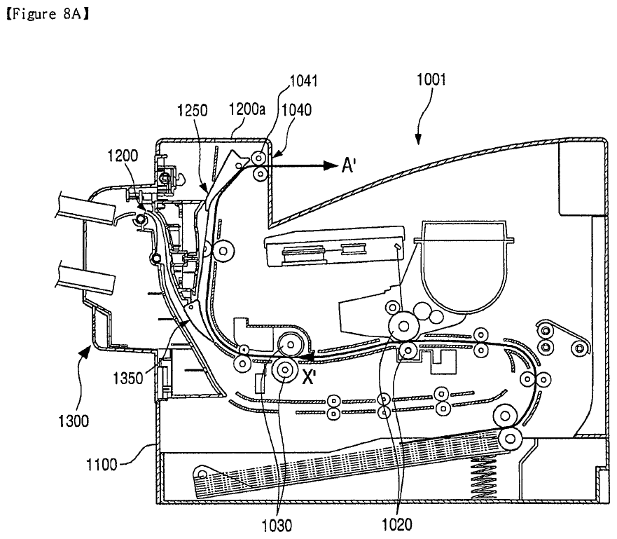

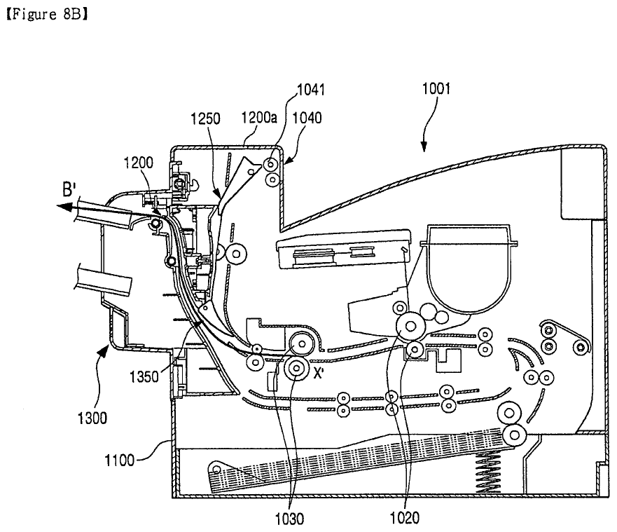

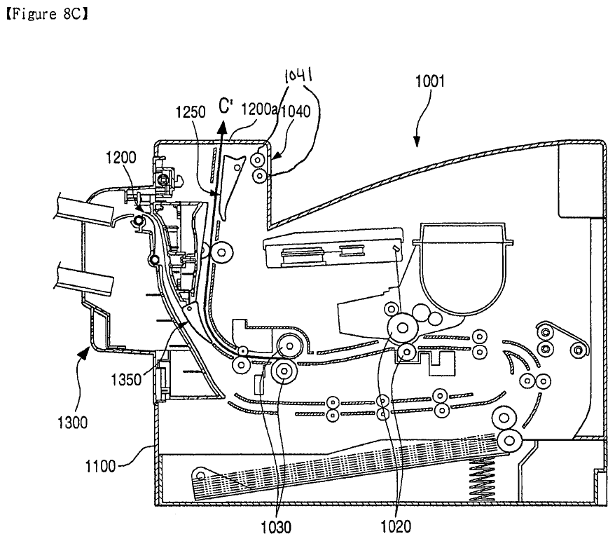

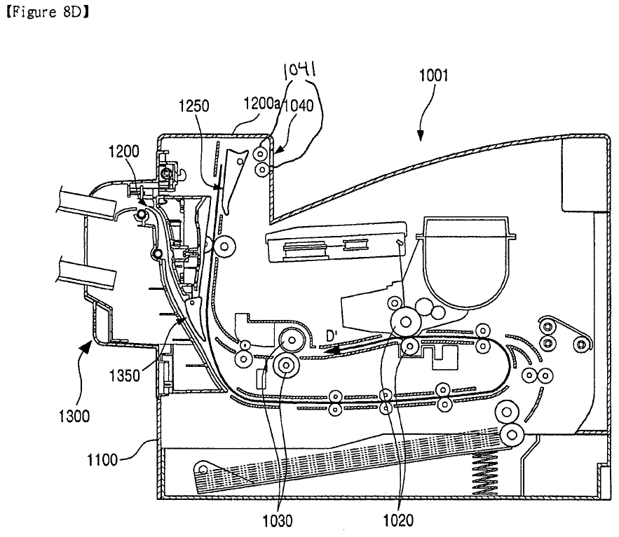

Referring to FIG. 2, the post-processing device 300 may be disposed on an upper surface of the main body 100. Referring to FIGS. 8A, 8B, 8C and 8D, the post-processing device 300 may be disposed on a side of the main body 100. The post-processing device 300 may, as necessary, be disposed on an upper surface or side of the main body 100 of the image forming apparatus 1.

The post-processing path selection device 350 may guide a paper passing through the fixing device 30 to any one of a discharging path (A, see FIG. 7A) guiding toward the discharging device 40 and a post-processing path (B, see FIG. 7B) branched from the discharging path A and guiding to the post-processing device 300.

The paper reverse device 200 will be described below in detail.

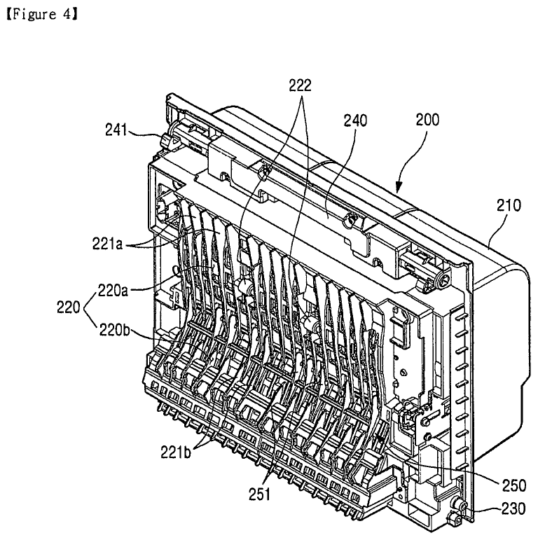

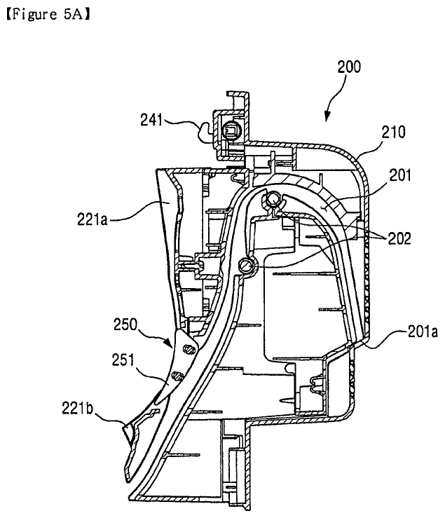

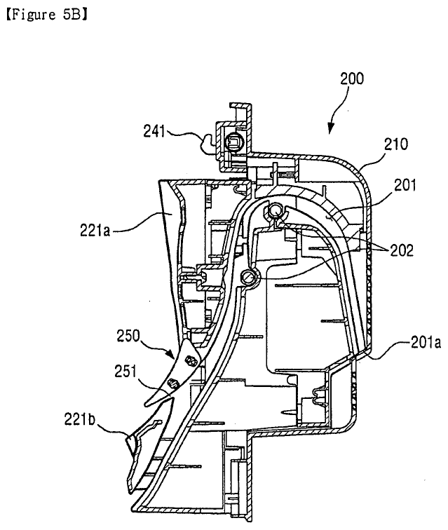

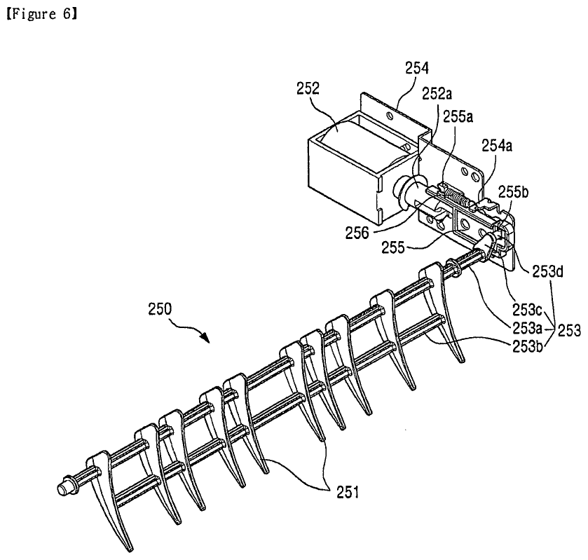

FIG. 4 is a perspective view illustrating a paper reverse device of FIG. 1. FIG. 5A is a cross-sectional view of a paper reverse device in which a second guide member of a reverse path selection device is disposed at a third position. FIG. 5B is a cross-sectional view of a paper reverse device in which a second guide member of a reverse path selection device is disposed at a fourth position. FIG. 6 is a perspective view illustrating a path selection device of FIG. 1.

Referring to FIGS. 4, 5A and 5B, the paper reverse device 200 includes an outer cover 210, an inner surface 220, a hinge protrusion 230, a detachable handle, and a reverse path selection device guiding papers to any one of a discharging path (A, see FIG. 7A) and a reverse path. In this regard, the paper reverse device 200 is provided with a reverse path (C, see FIG. 7C) therein.

The paper reverse device 200 is linked to a paper reverse space 201 in which a paper is reversed and a portion of a reentry path (D, see FIG. 7D) which is linked to the paper reverse space 201 and from which a paper of which the transfer direction is reversed is ejected.

The paper reverse space 201 is a space in which a paper is reversed, and is inverted u-shaped to reduce a space occupied by the paper reverse space 201. It is desirable that the paper reverse space 201 is formed to have a length sufficient to receive paper of various sizes.

It is desirable that one end 201a of the paper reverse space 201 is closed. This may, when a paper is reversed, provide a visual stability to the user by preventing the paper from coming out of the paper reverse device 200 and reentering the paper reverse device 200 in advance.

The paper reverse transfer roller 202 is disposed on the paper reverse space 201. It may be that at least two paper reverse transfer rollers 202 are disposed and are simultaneously disposed at predetermined intervals for smooth transfer of papers. In particular, it may be that at least one of a number of paper reverse transfer rollers 202 is disposed at a part of the paper reverse space 201 is bent the most. This is to naturally switch a transfer direction of a paper, provided that a paper is present in the paper reverse space 201.

The paper reverse transfer roller 202 may receive a driving power from a motor (not illustrated) rotating normally/reversely and rotate a direction of the paper. In detail, in a case in which a paper enters the paper reverse space 201 on the reverse path (C, see FIG. 7C), the paper reverse transfer roller 202 rotates clockwise in a state of being in contact with the paper and the paper is transferred close to one end 201a of the paper reverse space 201. In a case in which the paper is sufficiently close to one end 201a of the paper reverse space 201, the paper reverse transfer roller 202 rotates counterclockwise in a state of being in contact with the paper and the paper is drifted apart from the one end 201a of the paper reverse space 201. Accordingly, the paper is transferred to the reentry path (D, see FIG. 7D) by the paper reverse transfer roller 202.

In a case in which the paper reverse device 200 is attached to the main body 100 of the image forming apparatus 1, the outer cover 210 is connected to the outer surface of the main body 100. The outer cover 210 is made of opaque materials and thus, the user cannot see through the paper reverse device 200 from the outside. Accordingly, the user may be provided with a visual stability by preventing a direction of the paper from being reversed, that is, by preventing the paper from coming out of the paper reverse device 200 and reentering the paper reverse device 200 in advance.

Referring to FIG. 4, an inner surface 220 of the paper reverse device 200 includes an upper inner side 220a including a transfer roller 222 and a lower inner side 220b. The upper inner side 220a may form one side of a discharge path (A, see FIG. 7A) or a post-processing path (B, see FIG. 7B). In addition, the upper inner side 220a includes a first protrusion surface 221a which is projected long along a longitudinal direction of the discharge path (A, see FIG. 7A) or the post-processing path (B, see FIG. 7B). A number of the first protrusion surfaces 221a are formed, and are formed at predetermined intervals in an approximately perpendicular direction of the longitudinal direction of the discharge path (A, see FIG. 7A) or the post-processing path (B, see FIG. 7B).

Accordingly, the upper inner side 220a may reduce a contact area with a paper transferred along the discharge path (A, see FIG. 7A) or the post-processing path (B, see FIG. 7B), thereby reducing friction with the paper.

The upper inner side 220a may form one side of a discharge path (A, see FIG. 7A) or a post-processing path (B, see FIG. 7B). In addition, the upper inner side 220a includes a first protrusion surface 221a which is projected long along a longitudinal direction of the discharge path (A, see FIG. 7A) or the post-processing path (B, see FIG. 7B). A number of the second protrusion surfaces 221b are formed, and are formed at predetermined intervals in an approximately perpendicular direction of the longitudinal direction of the discharge path A. Accordingly, the lower inner side 220b may reduce a contact area with a paper transferred along the discharge path A, to thereby reduce friction with the paper.

The transfer roller 222 may be disposed at least one place from among the upper inner side 220a and the lower inner side 220b, and may be disposed at both the upper inner side 220a and the lower inner side 220b. When the transfer roller 222 is disposed between the first protrusion surfaces 221a, at least two transfer rollers 222 may be disposed at predetermined intervals in a perpendicular direction to the longitudinal direction of the discharge path. In addition, the transfer roller 222 is disposed between the second protrusion surfaces 221b, at least two transfer rollers 222 may be disposed at predetermined intervals in a perpendicular direction to the longitudinal direction of the discharge path.

One side of the paper reverse device 200 which includes an upper inner side 220a and a lower inner side 220b may form one side of the discharge path A or the post-processing path B. Accordingly, even if the paper reverse device 200 is provided in the main body 100, the paper reverse device 200 may form one side a discharge path A and a post-processing path to minimize space, and thereby a configuration included in the path can be reduced.

The second protrusion surface 221b may be formed at a position corresponding to a longitudinal direction of a discharge path (A, see FIG. 7A) at a position at which the first protrusion surface 221a is formed.

The hinge protrusion 230 is formed as being projected from the opposite sides of the lower end side of the side of the paper reverse device 200. The hinge protrusion 230 is hinge-connected to the coupling part (not illustrated) formed in the main body 100. Accordingly, in a state in which the paper reverse device 200 is coupled with the main body 100, in the case of a paper jam in the paper reverse device 200 or it is necessary to replace or repair the internal components of the paper reverse device 200, an upper side part of the paper reverse device 200 may be rotated about a hinge protrusion 230.

A projection part 241 connected with a handle (not illustrated) is provided in the detachable handle 240. The projection part 241 is fixed as being hooked to the projection part (not illustrated) of the main body 100. Accordingly, the paper reverse device 200 may be fixed as being coupled with the main body 100. The detachable handle 240 is an element for opening the paper reverse device 200 coupled with the main body 100. When a force is applied to the detachable handle 240 in a predetermined direction, the projection part 241 coupled with the detachable handle 240 is spaced apart from the projection part (not illustrated) of the main body 100. Accordingly, it is possible that one side of the paper reverse device 200 is spaced apart from the main body 100.

According to the user's need, the projection part 241 can be any combination structure as long as the main body 100 and the detachable handle 240 are fixed at a normal time and the fixing is released.

The reverse path selection device 250 is provided in the paper reverse device 200 and is disposed at a lower end of the upper inner surface. Referring to FIG. 6, the reverse path selection device 250 includes a second guide member 251, a second drive member 252, and a fixing shaft 253.

The second guide member 251 may be formed to be an approximate hook shape. However, the shape of the second guide member 251 is not limited thereto, and may be any shape that is capable of opening or closing the discharge path A or the reverse path C according to a movement of the second guide member 251.

A side of the second guide member which is in contact with a paper P being transferred may be a streamline shape. Accordingly, the second guide member 251 may reduce friction with the paper.

Referring to FIG. 4, a number of the second guide members 251 are disposed at predetermined intervals, and are disposed between the first protrusion surfaces 221a and between the second protrusion surfaces 221b. Accordingly, the second guide member 251 is not interfered with the first protrusion surface 221a and the second protrusion surface 221b even when the second guide member 251 is rotated about the second fixing shaft 253b. The second guide member 251 may open any one of the discharge path (A, see FIG. 7A) and the discharge path (C, see FIG. 7C) and simultaneously, close the other one.

Referring to FIG. 6, the reverse path selection device 250 includes a second drive member 252, a fixing shaft 253, a coupling member 254, a slide member 255, and an elastic member 256.

The second drive member 252 is a source of power to rotate the second guide member 251. The second drive member 252 is coupled with a controller (not illustrated) to control movement of the second guide member 251. The second drive member 252 includes a pressuring protrusion part 252a. The pressuring protrusion part 252a is coupled with the second drive member 252, and applies pressure to the slide member 255 while reciprocating according to driving of the second drive member 252.

The fixing shaft 253 includes a first fixing shaft 253a, a second fixing shaft 253b, a rotating protrusion 253c, and a slide protrusion 253d. The first fixing shaft 253a passes through one end portion of a number of second guide members 251, and may fix the number of second guide members 251 at predetermined gaps. One and the other ends of the first fixing shaft 253a are fixed to an inner side of the paper reverse device 200. A rotating protrusion 253c is formed in a perpendicular direction to the longitudinal direction of the first fixing shaft 253a at one end of the first fixing shaft 253a.

The second fixing shaft 253b passes through the other end part of a number of second guide members 251, and may fix the number of second guide members 251 at predetermined gaps. Unlike the first fixing shaft 253a, one and the other ends of the second fixing shaft 253b are not fixed. Accordingly, in a case in which the second guide member 251 is rotated about the first fixing shaft 253a, the second fixing shaft 253b may integrally rotated with the second guide member 251.

The coupling member 254 couples the second drive member 252 with the slide member 255. The coupling member 254 is fixedly coupled with one side of the second drive member 252 and an inner side of the paper reverse device 200. A first coupling protrusion 254a for coupling with one end of the elastic member 256 is formed in the coupling member 254. In addition, a slide groove (not illustrated) is formed one side of the coupling member 254, and a slide protrusion 253d is coupled with the slide protrusion and moved inside the slide groove.

The slide member 255 is disposed in parallel to one side of the coupling member 254, and a second coupling protrusion 255a for connecting with the other end of the elastic member 256 and a receiving groove 255b for receiving the slide protrusion 253d are formed.

One and the other ends of the elastic member 256 are coupled with the first coupling protrusion 254a and the second coupling protrusion 255a, respectively. Accordingly, the elastic member 256 may elastically couple the coupling member 254 with the slide member 255.

The operation of the reverse path selection device 250 will be described below.

The second drive member 252 is driven through a controller (not illustrated). The pressurizing protrusion part 252a coupled with the second drive member 252 applies pressure to one side of the slide member 255, and the slide member 255 applies pressure to the slide protrusion 253d coupled with the receiving groove 255b. The pressurized slide protrusion 253d is moved along a slide groove (not illustrated), and a rotating protrusion 253c integrally formed with the slide protrusion 253d is rotated. Thereafter, the second guide member 251 is rotated about the first fixing shaft 253a, and as illustrated in FIG. 5A, the second guide member 251 may open the discharge path A and may be disposed at a third position to close the discharge path B.

Thereafter, the pressurizing protrusion part 252a of the second drive member 252 is spaced apart again from the slide member 255 by driving of the second drive member 252. Accordingly, the slide member 255 having moved returns to a position prior to the movement by an elastic force of the elastic member 256, and a rotating protrusion 253c integrally formed with the slide protrusion 253d is rotated. Thereafter, the second guide member 251 is rotated about the first fixing shaft 253a, and as illustrated in FIG. 5B, the second guide member 251 may be disposed at a fourth position to open the reverse path B and close the discharge path B.

However, a power transfer configuration of the second drive member 252 and the second guide member 251 may be anything which is capable of transferring power of the second drive member 252 to the second guide member 251. Accordingly, according to needs of design, the second drive member 252 and a configuration to transfer power may be implemented in various methods, such as a solenoid, a clutch, a gear mechanism, and the like.

The post-processing path selection device and various paths of the image forming apparatus according to an example will be described below. In one example, a reverse path C is disposed upstream on the discharge path A compared with the post-processing path B. The path of a paper to be transferred corresponds to the upstream as it approaches the developing device 20 on the discharge path A and corresponds to the downstream as it moves farther away from the developing device 20.

FIG. 7A is a cross-sectional view illustrating a printing path and discharge path of an image forming apparatus. FIG. 7B is a cross-sectional view illustrating a post-processing path of an image forming apparatus. FIG. 7C is a cross-sectional view illustrating a reverse path of an image forming apparatus. FIG. 7D is a cross-sectional view illustrating a reentry path of an image forming apparatus.

The main body 100 includes a post-processing path selection device 350 guiding to any one of a discharge path A guiding a paper passing through a fixing device 30 to the discharging device 40 and a post-processing path B branched from the discharge path A to the post-processing device 300.

The post-processing path selection device 350 is provided in the main body 100, and has the same configuration as the reverse path selection device 250 as illustrated in FIG. 6. The first guide member 351 may be rotated about a shaft so that the post-processing path selection device 350 opens any one of the discharge path A and the post-processing path B and close the other. In addition, the post-processing path selection device 350 includes a first drive member (not illustrated) to rotate the first guide member 351.

As illustrated in FIG. 7A, the first guide member 351 may be rotated to a first position to open the discharge path A by a first drive member (not illustrated), and the first guide member 351 may be rotated to a second position to open the post-processing path B as illustrated in FIG. 7B.

Referring to FIG. 7A, a printing path X is a path through which the paper transferred by the pick-up device 10 passes through the developing device 20 and the fixing device 30 and the toner image is fixed on one side of the paper.

The discharge path A is a path through which a paper passing through the fixing device 30 is transferred to the discharging roller 41 of the discharging device 40 and discharged outside the main body 100 of the image forming apparatus 1. In this regard, the reverse path selection device 250 is at a third position, and the post-processing path selection device 350 is at a first position.

Referring to FIG. 7B, the post-processing path B is branched from the discharge path A. The first guide member 351 of the post-processing path selection device 350 is disposed at a second position by being rotated to close the discharge path A, and accordingly, a post-processing path B branched from the open path A and leading to the post-processing device 300 is opened.

In a case in which printing is carried out for one side of a paper as a one-side printing, a paper printed according to the printing path X is transferred along the discharge path A. In this regard, in the case where it is necessary to carry out post-processing for a paper for which printing is completed, a first guide member 351 of the post-processing path selection device 350 is rotated and disposed at a second position and thus, the discharge path A is closed. Accordingly, the post-processing path selection device 350 guides a paper to the post-processing device 300 along the post-processing path B. If post-processing is not necessary for a paper for which printing is completed, the first guide member 351 of the post-processing path selection device 350 is at a first position to close the post-processing path B and the paper is discharged along the discharge path A.

The paths of the image forming apparatus in the case where a paper is printed on both sides will be described below in detail.

Referring to FIG. 7C, the reverse path selection device 250 is at a fourth position to close the discharge path A and open the reverse path B. Accordingly, a paper of which one side is printed along the printing path X is transferred to the reverse path B branched from the discharge path A.

Referring to FIG. 7D, the reentry path D is a path to transfer a paper of which a transfer direction is reversed in the paper reverse device 200 to the developing device 20 to develop a toner image on the other side of the paper.

In the case of a double-sided printing, a paper is transferred along a printing path X and one side of the paper is printed. Thereafter, the second guide member 251 of the reverse path selection device 250 is disposed at a fourth position and the paper is transferred along the reverse path C. Thereafter, the paper of which the transfer direction is reversed in the paper reverse device 200 is linked to the printing path X via the reentry path D. The other side of the paper passing through the printing path X is printed. The paper of which one and the other sides are printed is transferred along the discharge path A or the post-processing path B according to whether post-processing is necessary or not. If it is not necessary to carry out post-processing for the paper, the first guide member 351 of the post-processing path selection device 350 is at a first position and accordingly, the discharge path A is opened. Accordingly, the paper is discharged outside the main body 100 along the discharge path A. Meanwhile, in the case where it is necessary to carry out post-processing for the paper, the first guide member 351 of the post-processing path selection device 350 is at a second position and accordingly, the post-processing path B is opened. Accordingly, the paper is guided to the post-processing device 300 along the post-processing path B.

Accordingly, one side of the paper reverse device 1200 form the post-processing path so that space may be reduced, and thereby a configuration for forming a path can be reduced.

Another example of the present disclosure will be described below. In another example, a reverse path C′ is disposed in a downstream on the discharge path A′ compared with the post-processing path B′. The paper transferred on the discharge path A′ corresponds to upstream as it is closer to the fixing device 1030.

FIG. 8A is a cross-sectional view illustrating a printing path and discharge path of an image forming apparatus, according to another example. FIG. 8B is a cross-sectional view illustrating a post-processing path of an image forming apparatus, according to an example. FIG. 8C is a cross-sectional view illustrating a reverse path of an image forming apparatus, according to an example. FIG. 8D is a cross-sectional view illustrating a reentry path of an image forming apparatus, according to another example.

Referring to FIGS. 8A, 8B, 8C and 8D, the paper reverse device 1200 is disposed at an upper side part of the main body 1100. One end 1200a of the paper reverse device 1200 is opened. Accordingly, even when a large-size and long paper is reversed, the paper reverse device 1200 does not need a large space including all reversed papers.

The paper reverse device 1200 includes a post-processing path selection device 1350. The configuration of the post-processing path selection device 1350 is the same as that of the reverse path selection device 250 as illustrated in FIG. 6. The post-processing path selection device 1350 may branch the post-processing path B′ from the discharge path A′. In detail, in the case where the post-processing path selection device 1350 is rotated downward and disposed at a fifth position, the post-processing path B′ is closed and the discharge path A′ is opened. Referring to FIG. 8B, in the case where the post-processing path selection device 1350 is disposed at a sixth position which is rotated counterclockwise from the fifth position, the post-processing path (B′ see FIG. 8B) is opened. Referring to FIG. 8D, in the case where the post-processing path selection device 1350 is disposed at a seventh position which is rotated counterclockwise from the fifth position, the reentry path (D′, see FIG. 8D) is opened.

The main body 1100 includes a reverse path selection device 1250. The configuration of the reverse path selection device 1250 is the same as that of the reverse path selection device 250 as illustrated in FIG. 6. The reverse path selection device 1250 may branch the reverse path C′ from the discharge path A′. In detail, as illustrated in FIG. 8A, in the case where the reverse path selection device 1250 is disposed at an eighth position, the reverse path C′ is closed and the discharge path A′ is opened. Referring to FIG. 8C, at a ninth position at which the reverse path selection device 1250 is further rotated clockwise than the eighth position, the discharge path A′ is closed and the reverse path C′ is opened.

The operation of another example will be explained below with reference to FIGS. 8A, 8B, 8C and 8D.

Referring to FIG. 8A, a printing path X′ is a path through which the paper transferred by the pick-up device 1010 passes through the developing device 1020 and the fixing device 1030 and the toner image is fixed on one side of the paper.

The discharge path A′ is a path through which a paper passing through the fixing device 1030 is transferred to the discharge roller 1041 of the discharge part 1040 and discharged outside the main body 1100 of the image forming apparatus 1001. In this regard, the post-processing path selection device 1350 is disposed at a fifth position, and the reverse path selection device 1250 is disposed at an eighth position.

Referring to FIG. 8B, the post-processing path B′ is branched from the discharge path A′. The post-processing path selection device 1350 is disposed at a sixth position and accordingly, a post-processing path B′ branched from the open path A′ and leading to the post-processing device 1300 is opened.

As for a one-side printing where printing is carried out for one side of a paper, a paper printed along the printing path X′ is transferred along the discharge path A′. In this regard, in the case where it is necessary to carry out post-processing for a paper for which printing is completed, the post-processing path selection device 1350 is disposed at the sixth position and closes the discharge path A′ and guides the paper to the post-processing device 1300 along the post-processing path B′. In the case where it is not necessary to carry out post-processing for a paper for which printing is completed, the post-processing path selection device 1350 is disposed at a fifth position to close the post-processing path B′ and the reverse path selection device 1250 is disposed at an eighth position to close the reverse path C′ and the discharge path A′. Accordingly, the paper is transferred along the discharge path A′.

The path of the image forming apparatus 1001 in the case where a paper is printed on both sides will be described below.

Referring to FIG. 8C, the post-processing path selection device 1350 is disposed at a fifth position, and the reverse path selection device 1250 is disposed at a ninth position. Accordingly, a paper of which one side is printed along the printing path X′ is transferred along the reverse path C′. A transfer direction of the transferred paper is reversed in the paper reverse device 1200. Thereafter, as illustrated in FIG. 8D, the post-processing path selection device 1350 is disposed at a seventh position, and the paper is transferred to the developing device 1020 along the reentry path D′ and the other side of the paper is printed.

In the case where it is necessary to carry out post-processing for the paper of which the other side is printed, the post-processing path selection device 1350 is disposed at a sixth position and transferred to the post-processing device 1300. In the case where it is not necessary to carry out post-processing for the paper of which the other side is printed, the post-processing path selection device 1350 is disposed at a fifth position and the reverse path selection device 1250 is disposed at an eighth position and thus, paper is discharged outside the main body 1100 along the discharge path A′.

As described above, even if the post-processing device 1300 is disposed at a side of the main body 1100, one side of the paper reverse device 2200 form the post-processing path B′ so that space may be reduced, and thereby a configuration for forming a path can be reduced.

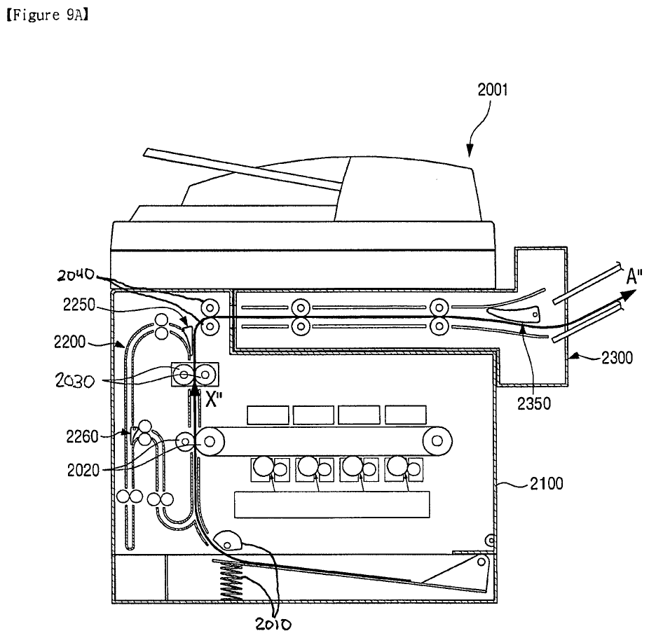

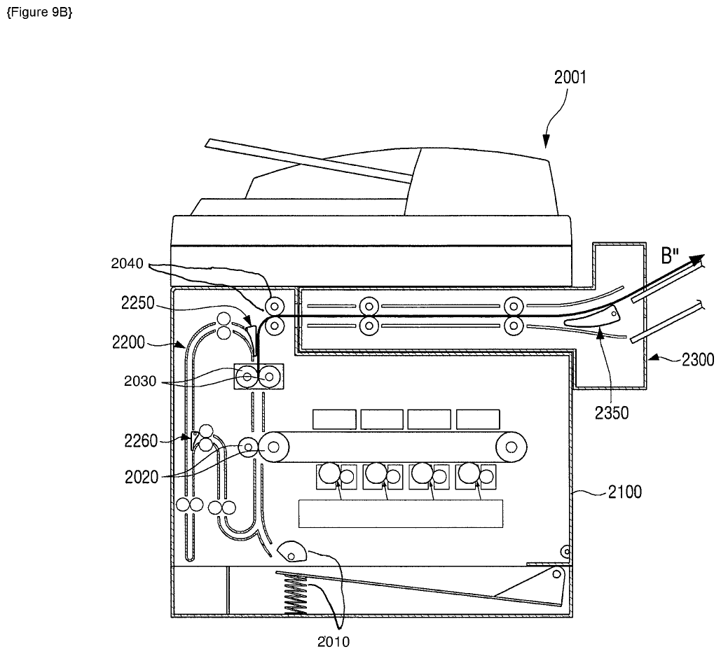

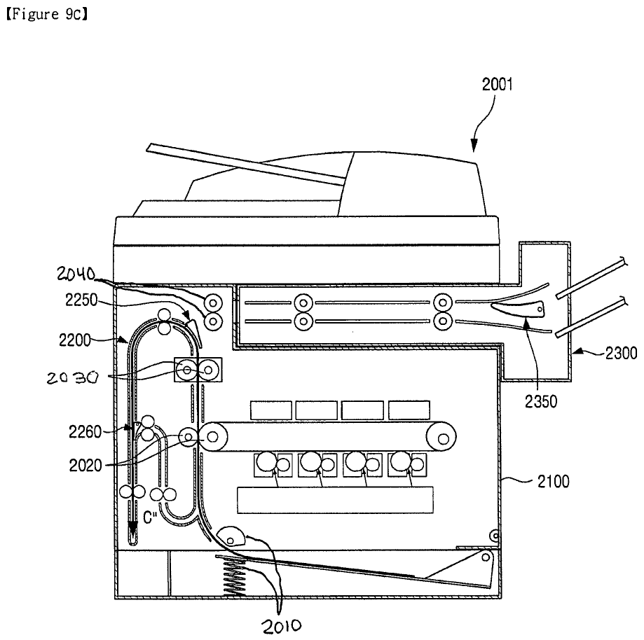

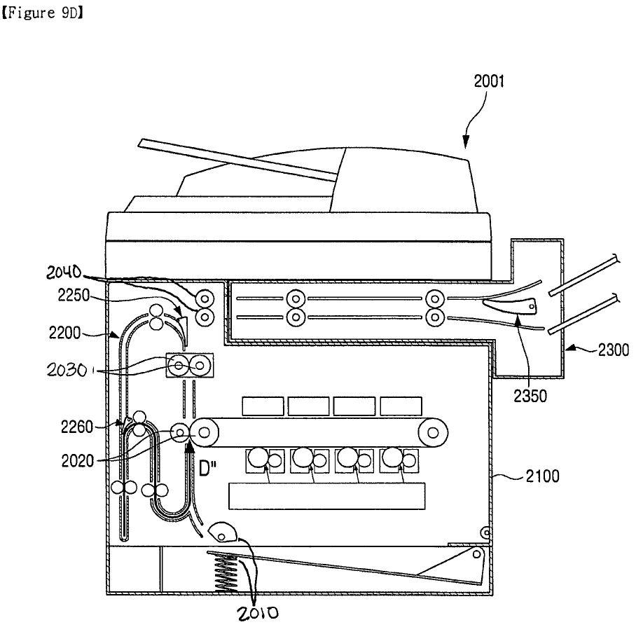

Another example of the present disclosure will be described below. FIG. 9A is a cross-sectional view illustrating a printing path and discharge path of an image forming apparatus, according to another example. FIG. 9B is a cross-sectional view illustrating a post-processing path of an image forming apparatus, according to yet another example. FIG. 9C is a cross-sectional view illustrating a reverse path of an image forming apparatus, according to an example. FIG. 9D is a cross-sectional view illustrating a reentry path of an image forming apparatus, according to yet another example.

An example according to FIGS. 7A, 7B, 7C and 7D and another example according to FIGS. 8A, 8B, 8C and 8D are disclosures which are all implemented in an image forming apparatus of an S-type path. Conversely, yet another example according to FIGS. 9A, 9B, 9C and 9D corresponds to an image forming apparatus of a C-type path.

In detail, in the S path-type image forming apparatus, a path sequentially linking a pick-up device, a developing device, a fixing device and a discharging device is arranged in a substantially S shape. In the C path-type image forming apparatus, a path sequentially linking a pick-up device, a developing device, a fixing device and a discharging device is arranged in a substantially C shape.

Referring to FIG. 9A, the image forming apparatus 2001 includes a reverse path selection device 2250, a post-processing path selection device 2350, and a reentry path guide device 2260.

A printing path X″ is a path through which the paper transferred by the pick-up device 2010 passes through the developing device 2020 and the fixing device 2030 and the toner image is fixed on one side of the paper.

The discharge path A″ is a path through which a paper passing through the fixing device 2030 is transferred to the discharging device 2040 and discharged outside the main body 2100 of the image forming apparatus 2001. In this regard, the reverse path selection device 2250 is disposed at a twelfth position to close the reverse path (C″, see FIG. 9C) and open the discharge path A″, and the post-processing path selection device 2350 is disposed at a tenth position to close the post-processing path (B″, see FIG. 9B) and open the discharge path A″.

Referring to FIG. 9B, the post-processing path B″ is branched from the discharge path A″. The post-processing path selection device 2350 is disposed at an eleventh position and accordingly, a post-processing path B′ branched from the open path A′ and leading to the post-processing device 2300 is opened.

As for a one-side printing where printing is carried out for one side of a paper, a paper printed along the printing path X″ is transferred along the discharge path A″. In this regard, in the case where it is necessary to carry out post-processing for a paper for which printing is completed, the post-processing path selection device 2350 is disposed at the eleventh position and closes the discharge path A′. Accordingly, the post-processing path selection device 2350 guides a paper to the post-processing device 2300 along the post-processing path B″. In the case where it is not necessary to carry out post-processing for a paper for which printing is completed, the post-processing path selection device 2350 is disposed at a tenth position to close the post-processing path B″, and the reverse path selection device 2250 is disposed at a twelfth position to close the reverse path C′ and open the discharge path A′. Accordingly, the paper is discharged along the discharge path A′.

The path of the image forming apparatus 2001 in the case where a paper is printed on both sides will be described below.

Referring to FIG. 9C, the reverse path selection device 2250 is disposed at a thirteenth position, and the reentry path guide device is disposed at a fourteenth position. Accordingly, a paper of which one side is printed along the printing path X″ is transferred along the reverse path C″.

Referring to FIG. 9D, a transfer direction of the transferred paper is reversed in the paper reverse device 2200. In this regard, the reentry path guide device 2260 is disposed at a fifteenth position, and a paper of which a transfer direction is reversed is transferred to the developing device 2020 along the reentry path D″ and the other side of the paper is printed.

In the case where it is necessary to carry out post-processing for the paper of which the other side is printed, the post-processing path selection device 2350 is disposed at an eleventh position and transferred to the post-processing device 2300. In the case where it is not necessary to carry out post-processing for a paper of which the other side is printed, the post-processing path selection device 2350 is disposed at a tenth position and a paper is discharged outside the main body 2100.

As described above, the present disclosure may be applied to an image forming apparatus of an S path-type and also to an image forming apparatus of a C path-type.

The foregoing examples are merely and are not to be construed as limiting the present disclosure. The present teaching can be readily applied to other types of apparatuses. Also, the description of the examples of the present disclosure is intended to be illustrative, and not to limit the scope of the claims, and many examples, modifications, and variations will be apparent to those skilled in the art.

What is claimed is:

1. An image forming apparatus, comprising:
a main body;
a pick-up device disposed inside the main body, the pick-up device to pick up a printing medium;
a developing device disposed inside the main body to develop an image on a side of the printing medium picked up by the pick-up device;
a fixing device disposed inside the main body, to fix the image developed on the side of the printing medium;
a paper reverse device to guide the printing medium from a transfer direction of the printing medium passing through the fixing device, through a reverse path to the developing device and the fixing device, to develop and fix another image on other side of the printing medium;
a discharging device to discharge the printing medium outside the main body;
a post-processing device provided in the main body; and
a post-processing path selection device rotatable to
a first position to guide the printing medium through a discharge path to guide the printing medium passing through the fixing device to the discharging device, and
a second position to guide the printing medium from the discharge path to a post-processing path branched from the discharge path to guide the printing medium to the post-processing device.

2. The image forming apparatus as claimed in claim 1, wherein the post-processing path selection device comprises:
a first guide member rotatable to
the first position to open the discharge path and close the post-processing path simultaneously, and
the second position to close the discharge path and open the post-processing path simultaneously; and
a first drive member to control the first guide member to rotate towards the first position to open the discharge path and the second position to open the post-processing path.

3. The image forming apparatus as claimed in claim 1, wherein the paper reverse device comprises:
a reverse path selection device rotatable to:
a first position to guide the printing medium to the discharge path, and
a second position to guide the printing medium from the discharge path to the reverse path connected to the discharge path and branched from the discharge path.

4. The image forming apparatus as claimed in claim 3, wherein the reverse path is disposed more upstream on the discharge path than the post-processing path with respect to the transfer direction.

5. The image forming apparatus as claimed in claim 3, wherein the reverse path is disposed more downstream on the discharge path than the post-processing path with respect to the transfer direction.

6. The image forming apparatus as claimed in claim 4, wherein the reverse path selection device comprises:
a second guide member rotatable to
the first position to open the discharge path and close the reverse path simultaneously, and
the second position to close the discharge path and open the reverse path simultaneously; and
a second drive member to rotate the second guide member towards the first position to open the discharge path and the second position to open the reverse path.

7. The image forming apparatus as claimed in claim 1, wherein a portion of the discharge path is formed by one side of the paper reverse device.

8. The image forming apparatus as claimed in claim 1, wherein a portion of the post-processing path is formed by one side of the paper reverse device.

9. The image forming apparatus as claimed in claim 1, wherein the post-processing device is disposed on a side of the main body.

10. The image forming apparatus as claimed in claim 1, wherein the post-processing device is disposed on an upper surface of the main body.

11. The image forming apparatus as claimed in claim 1, wherein the paper reverse device is hinge-connected to the main body.

12. The image forming apparatus as claimed in claim 1, wherein the paper reverse device is detachably connected to the main body.

13. The image forming apparatus as claimed in claim 3, wherein a reentry path connected to the paper reverse device, to guide the printing medium in the paper reverse device to the developing device, is formed in the main body.

14. An image forming apparatus, comprising:
a main body;
a pick-up device disposed inside the main body, the pick-up device to pick up a printing medium;
a developing device disposed inside the main body to develop an image on a side of a printing medium picked up by the pick-up device;
a fixing device disposed inside the main body, to fix the image developed on the side of the printing medium;
a paper reverse device to guide the printing medium from a transfer direction of the printing medium passing through the fixing device, through a reverse path to the developing device and the fixing device, to develop and fix another image on other side of the printing medium;
a discharging device to discharge the printing medium outside the main body; and
a post-processing device provided in the main body,
wherein the paper reverse device includes a reverse path selection device rotatable to
a first position to guide the printing medium to a discharge path to guide the printing medium passing through the fixing device to the discharging device, and
a second position to guide the printing medium from the discharge path to the reverse path connected to the discharge path and branched from the discharge path to guide the printing medium to the post-processing device.

15. The image forming apparatus as claimed in claim 14, further comprising:
a post-processing path selection device rotatable to
a first position to guide the printing medium through the discharge path to guide the printing medium passing through the fixing device to the discharging device, and
a second position to guide the printing medium from the discharge path to a post-processing path branched from the discharge path, to guide the printing medium to the post-processing device.
